(19) United States
(12) Patent Application Publication
(10) Pub. No.: US 2008/0120167 A1
(43) Pub. Date: May 22, 2008

(54) Personal Inventory and Marketing Electronic System and Method

(75) Inventors: Joachim Guenster, Baldham (DE); Thomas Binzinger, Baldham (DE)

Correspondence Address: AC TECHNOLOGIES, S.A., MAISON 2, LEITHUM, 9910, omitted

(73) Assignee: AC TECHNOLOGIES S.A., Leithum (LU)

(21) Appl. No.: 11/941,113

(22) Filed: Nov. 16, 2007

Related U.S. Application Data
(60) Provisional application No. 60/866,220, filed on Nov. 17, 2006.

(51) Int. Cl. G06Q 30/00

(52) U.S. Cl. 705/10

(57) ABSTRACT

The present invention relates generally to a personal inventory and marketing electronic system and method. The system comprises a RFID tag interrogator that collects data from RFID tags attached to user's items, a host computer that stores and processes such data, a computer interface and a software resident on the host computer. The computer-implemented method is able to provide a personal inventory of user's items placed at the interrogation locations by collecting data stored on RFID tags. Subsequently, the method includes means for offering such items for sale and exchange in online platforms. It also allows generating recommendation lists of items predicted to be of interest for the user and purchasing such items upon authorization of the user.

### CROSS-REFERENCE TO RELATED APPLICATIONS

This application claims priority from U.S. Provisional Patent Application Ser. No. 60/866,220, filed on 17 Nov. 2006 and entitled Personal Inventory Electronic System and Method, the contents of which are hereby fully incorporated by reference.

### BACKGROUND OF THE INVENTION

1. Field of the Invention

This invention relates generally to RFID inventory systems used in conjunction with software applications.

2. Description of the Related Art

The technology called Radio Frequency Identification (RFID) has been developed for identification, tracking, sorting or detection of a wide variety of objects. A basic RFID system consists of a RFID tag interrogator and a RFID tag that is electronically programmed with data. Data stored in the RFID tag is retrieved by the RFID tag interrogator and transmitted to a host computer to be processed according to the needs of a particular application.

In the last years, RFID technology has been widely adopted in virtually every industry, including transportation, waste management, manufacturing, postal tracking, airline baggage reconciliation, retail etc. Additionally, there exist other applications for this technology that complement the efforts of retailers and enables e-commerce opportunities.

Nevertheless, commercially available RFID inventory systems have generally addressed industrial needs while individual consumers have been partially excluded from the advantages that RFID systems may bring to the way they privately manage, select, purchase o sell goods and services.

There currently exist a need for easy manageable personal inventory systems. Users should be able to save the time and effort that the collection and input of data implies when making inventory of their goods. Additionally, a method for managing the different actions that may occur in relation to a specific item should be offered in a way that requires a minimum of attention and effort on the user's side.

For the foregoing reasons, this invention provides users with a simple, affordable and interactive system and method for creating a personal inventory based on RFID technology and for processing the collected information to improve their online marketing experience.

### SUMMARY

The present invention relates to a personal inventory and online marketing system and method. More specifically, the invention relates to a computer-implemented method that allows for creating a personal inventory by using RFID technology. Data contained in the personal inventory is then processed by a software application to manage and improve the sale or exchange of inventory-listed items and purchase of new items online. The system comprises a RFID tag interrogator, a host computer connected to an external network, a computer interface and a software stored on the host computer.

In a first embodiment, the RFID tag interrogator scans RFID tags attached, embedded within or otherwise associated with an item deposited or placed within an interrogation location. The information stored on the RFID tag is retrieved by the RFID tag interrogator and transmitted to the host computer for storage and processing. The method consist of collecting information from RFID tags and processing such data to facilitate first, the marketing of used items listed in the inventory and second the purchase of missing items belonging to a particular group of items.

The computer-implemented method of this invention allows on the one hand for creating a personal inventory by using a technology that it has been mainly used for industrial application rather than for private consumer applications. On the other hand, programming means of the system allows for processing and managing the information contained in the inventory to address the very particular needs and preferences of the user when buying, selling, or exchanging items online.

These and other features aspects and advantages of the present invention will become better understood with reference to the following description and appended claims.

### DETAILED DESCRIPTION OF THE INVENTION

The present invention refers to a personal inventory and marketing electronic system and method.

The system comprises a RFID tag interrogator capable of reading RFID tags either actively or passively, a host computer to which the RFID tag interrogator is associated, a user interface and a software resident on the host computer.

RFID tags may be attached to, embedded within or otherwise associated with an item deposited or placed at locations in which the system is installed to create a RFID interrogation location. The RFID tag interrogator scans RFID tags that enter the interrogation locations. Such locations may cover, without being limited to, the zone occupied by a closet, armoire, wardrobe or any other similar entity. The RFID tag interrogator retrieves the data stored on the RFID tags and transmits such information wirelessly to the host computer for storage and processing.

The RFID tag interrogator is typically composed of an antenna and a coupler. The antenna is responsible for sending and receiving radio signals and for transferring the data received from the RFID tag to the coupler. The coupler controls data acquisition and communication. It is associated to the host computer. If the RFID tag is a passive tag, the emission of the radio frequency energy by the RFID tag interrogator causes the passive RFID tag to emit a series of waveforms. If the RFID tag is an active tag, it emits waveforms even if the RFID interrogator tag does not generate the radio frequency energy.

In one of the embodiments of the invention, the system consists in a plurality of radio frequency (RF) antennas that are set up to create multiple interrogation locations. The RFID tag interrogator outputs RF power from a single transmitter/receiver port to the multiple antennas via a splitter/combiner. The transmitter/receiver port provides each of the antennas with RF power to produce interrogation fields within the interrogation locations. These interrogation fields deliver a tag detection signal to the RFID reader when user's goods are placed within the interrogation locations. By installing this plurality of radio frequency (RF) antennas, the system is able to scan items that are placed or distributed in different places of user's home, without having to install the whole system at each location desired to be scanned.

The host computer is associated to a coupler for receiving the data sent from the antenna(s) associated to the RFID tag interrogator. The host computer is also connected to an external network such as but not limited to the internet.

The software resident on the host computer processes the collected information. It includes means for sorting, storing and processing the information. In this specification the terms “software” and “programming means” are used as synonyms and mean any set of instructions stored on the host computer that direct the system to perform the different applications of the system and method described in this specification. The RFID tag interrogator detects RFID tags and collects the data stored thereon. The software directs the host computer to connect to the external network in order to retrieve missing or additional identification information on RFID tags. This identification information normally comprises historical and attributes of the RFID tagged product and it might be held in the original manufacture's system, in databases belonging to the companies that handled the RFID tagged item during its track through the supply chain, etc. The integration of these various sources of information allows the system being always able to identify the RFID tag. This data may be combined with product information concerning the RFID tagged item collected from other sources like, without being limited to, information provided by the user him- or herself.

The host computer processes the entire data based on the data collected from the RFID tag and the additional data on the RFID tagged item collected from external sources and initiates a number of actions.

The method consists of collecting RFID information data and processing such data to facilitate first, the marketing of new or used items listed in the inventory and second, the purchase of missing items belonging to a particular group or category.

The method is executed by software that facilitates marketing. Product related information of RFID tags like historical, manufacturer, and distributor, as well as information provided by other sources, is all stored on the host computer. It then processes all data determining product marketing characteristics like but not limited to average market price, consumption time and availability of the product at retailer or manufacture stores.

The user has access to the system through a user interface operated by the host computer. The user may access the system by using a login name and password or any other similar identification method. The user interface may comprise, without being limited to, screen menus and icons, keyboard shortcuts, command language and online help, physical buttons and dials as well as input devices, such as a touch screen, remote control, and natural language or voice recognition. After logging on, the user is able to create its personal profile that contains personal information like delivery address and charge authorization data among others. Responsive to the user's request, the host computer displays different messages or alerts related to the items listed in the inventory. In addition, the user may choose to be informed about necessary actions on the inventory through other information channels including but not limited to emails or text messages (SMS).

The messages consist of alarms and warnings corresponding different categories. One of these categories refers to the consumption time. Once a product has been already used for a period of time predetermined by the user, the system requests authorization from the user to offer the item on different online sales platforms like, but not limited to, ebay. The system displays an average price according to the information provided by the system-associated external databases and online stores. The system also provides information on the starting and ending prices of similar items sold on the online platform(s) recently. This information helps the user to decide on the starting price of the sale auction for the used item. Based on the same information, the user can also decide not to offer the item for sale if the ending prices of similar sold items are lower than user's expectations. Alternatively, the user may prefer to exchange the item for another item of his or her interest in an exchange platform.

The user can also use the system for sale or exchange of new items listed in the inventory. In this case, the user shall identify the items that she or he wants to offer on the online platform(s).

The system requires the user to provide additional information on the new or used item to be sold or exchanged on online platforms. This request may include a picture of the item as well as a description of its conditions like a reference to any flaws, wear or damage. Sold or exchanged items are automatically deleted from the inventory. A record of the sold items as well as the ending price charged to the buyer is stored on the computer. The system updates the inventory every time when the user sells or exchanges an item.

The system also registers when an inventory-listed item is located out of the interrogation location. By using this data, the system generates alerts on items that are currently being offered for sale or exchange but that are not placed at the interrogation location. In this way, the user is warned that in case of damage or lost of the item in question, the sale or exchange action would be cancelled. These alerts may consist of text messages, emails or any other messaging system that are sent to mobile devices such but not limited to mobile phones or pocket PCs.

In another embodiment, the system identifies the items of the inventory generating a list of additional items that are predicted to be of interest of the user. These items recommended for purchasing may refer, without being limited to, pieces of a designer collection, books of an specific author or publishing house, compact discs (“CDs”) of an specific singer, orchestra or band, digital versatile discs (DVDs) of an specific genre, and in general to any kind of items that are placed at a user's interrogation location and that have been previously classified into a collection for example by their manufacturer or by a retailer's online shop. The host computer connects to the external network to search in online stores or any other similar external sources. Then, it sorts the information related to a specific product so that the user is able to know which piece of the collection is missing, at which stores is available and the retailer's price, among others. Product availability is determined under geographic parameters if the user determines the system to do so. In case contrary, the system will browse among available online purchase offers without applying any geographical criteria. Purchased items are tracked in the user's purchase record which may include, without being limited to, product type, brand name, retailer and cost. The system also updates the inventory every time when the user purchases an item. Arrangements related to payment and delivery of purchased items are automatically performed by the system by using user's information stored on the computer.

### CONCLUSIONS, RAMIFICATIONS AND SCOPE OF THE INVENTION

The invention described in this specification provides the user with an easy manageable personal inventory and marketing system and method. On the one hand, it allows users to save the time and effort that the collection and input of data implies when making inventory of their goods. On the other hand, the method allows for managing the sale, exchange, and purchase of items in a way that requires a minimum of attention and effort on the user's side. It also addresses the specific needs and preferences of the user, improving their private inventory and online marketing experience.

1. A computer-implemented method for creating a personal inventory to facilitate online marketing, comprising:
(a) providing a RFID tag interrogator which is able to collect the data stored on the RFID tags attached, embodied or otherwise associated to user's items located within an interrogation location, said RFID tag interrogator transmitting said data to a host computer;
(b) providing a host computer which is associated to said RFID tag interrogator and connected to an external network, the host computer having storage and processing means for receiving, collecting, storing, sorting and processing the data received from said RFID tag interrogator and from external sources;
(c) providing a user interface operatively connected to said processing and storage means that allows the user to access the personal inventory, submit required information and set parameters for performing of inventory and marketing applications by said programming means,
(d) providing programming means stored on said host computer which:
1. create a personal inventory of user's items by using i. data collected from said RFID tags, ii. information provided by the user and iii. information collected from external sources;
2. provide marketing characteristics and additional data on said user's items by collecting information from sources available in the external network to which the host computer is connected;
3. generate a list of items predicted to be of interest to the user, said list based on information contained on the personal inventory and data collected from sources available in the external network, said items of interest being automatically purchased upon request of the user;
4. incorporate purchased items into the personal inventory;
5. track purchase operations in a user's purchase record, said purchase record including product type, brand name, retailer, and price;
6. identifying user's items for sale or exchange in online platforms, said identification based on the expiration date of a period of use previously determined by the user, said sale or exchange being performed upon authorization of the user only;
7. delete sold and exchanged user's items from the personal inventory;
8. incorporate items received from an exchange operation into the personal inventory;
9. track sale and exchange operations in a user's sale record, said sale record including product type, brand name, retailer and price;
10. provide the user with a monthly account statement of sale, exchange and purchase operations.

2. The computer-implemented method of claim 1 wherein said RFID tag interrogator retrieve the data stored on RFID tags from multiple interrogation locations in which user's items are located.

3. The computer-implemented method of claim 1, wherein items offered for sale or exchange are new items, said items being offered in online platforms upon request of the user.

4. The computer-implemented method of claim 1, wherein (d) 3 further includes presenting to the user information about product characteristics, availability, average retailer's price and expected time of delivery.

5. The computer-implemented method of claim 1, wherein (d) 6 further includes:
i. generating alerts to inform the user on the expiration of the period of use of an item ii. generating alerts when a sale or exchange action begins and the offered item is not located within the interrogation location.
